(19) United States
(12) Patent Application Publication
(10) Pub. No.: US 2026/0238083 A1
(43) Pub. Date: Aug. 13, 2026

(54) POWER TOOL, COVER UNIT, AND AUXILIARY COVER

(71) Applicant: MAKITA CORPORATION, Anjo-shi (JP)

(72) Inventors: Tomoki ITO, Anjo-shi (JP); Takahiro KAWAKAMI, Anjo-shi (JP); Yuto NAKADORI, Anjo-shi (JP)

(73) Assignee: MAKITA CORPORATION, Anjo-shi (JP)

(21) Appl. No.: 19/529,652

(22) Filed: Feb. 4, 2026

(30) Foreign Application Priority Data
Feb. 12, 2025 (JP) 2025-020925
Oct. 21, 2025 (JP) 2025-177335

(51) Int. Cl. H02K 7/14; B24B 55/05; B25F 5/00; B25F 5/02

(52) U.S. Cl. CPC H02K 7/145; B24B 55/052; B25F 5/001; B25F 5/02; B25F 5/026

(57) ABSTRACT

A power tool may include: a motor; a power transmission mechanism coupled to the motor; a housing that houses the motor and the power transmission mechanism; a holding part coupled to the power transmission mechanism; a tip tool held by the holding part and rotatable about a rotation axis; and a cover unit. The cover unit may include: a main cover attached to the housing and covering at least a part of the tip tool; and an auxiliary cover detachably attached to the main cover. The auxiliary cover may include: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

### CROSS REFERENCE TO RELATED APPLICATIONS

This application claims priority to Japanese Patent Application No. 2025-020925 filed on February 12, 2025 and Japanese Patent Application No. 2025-177335 filed on October 21, 2025. The entire contents of the priority applications are incorporated herein by reference.

### TECHNICAL FIELD

The art disclosed herein relates to a power tool, a cover unit, and an auxiliary cover.

### BACKGROUND ART

US Patent Application Publication No. 2022/0203499 describes a power tool. The power tool includes a motor; a power transmission mechanism coupled to the motor; a housing that houses the motor and the power transmission mechanism; a holding part coupled to the power transmission mechanism; a tip tool held by the holding part and rotatable about a rotation axis; and a cover unit. The cover unit includes a main cover attached to the housing and covering at least a part of the tip tool; and an auxiliary cover detachably attached to the main cover. The auxiliary cover includes a cover body; and a contact member supported by the cover body and including a first flat contact surface and a second flat contact surface inclined relative to the first flat contact surface.

### SUMMARY

It may be desired to change the positional relationship between first and second flat contact surfaces according to the shapes of workpieces. The above-described power tool requires a full replacement of the contact member in order to change the positional relationship between the first flat contact surface and the second flat contact surface. The disclosure herein provides a technology that enables changing the positional relationship between a first flat contact surface and a second flat contact surface without requiring a component replacement.

A power tool disclosed herein may comprise a motor; a power transmission mechanism coupled to the motor; a housing that houses the motor and the power transmission mechanism; a holding part coupled to the power transmission mechanism; a tip tool held by the holding part and rotatable about a rotation axis; and a cover unit. The cover unit may comprise: a main cover attached to the housing and covering at least a part of the tip tool; and an auxiliary cover detachably attached to the main cover. The auxiliary cover may comprise: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

A cover unit for a power tool disclosed herein may comprise: a main cover; and an auxiliary cover detachably attached to the main cover. The auxiliary cover may comprise: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

An auxiliary cover of a cover unit for a power tool disclosed herein may comprise: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

The configurations above enable changing the positional relationship between the first flat contact surface and the second flat contact surface without requiring component replacement.

### BRIEF DESCRIPTION OF DRAWINGS

FIG. 1 is a perspective view of a power tool 2 according to a first embodiment as viewed from the upper front right side.

FIG. 2 is a longitudinal cross-sectional view of a front portion of the power tool 2 according to the first embodiment.

FIG. 3 is a perspective view of a cover unit 6 according to the first embodiment as viewed from the upper front left side.

FIG. 4 is a perspective view of the cover unit 6 according to the first embodiment as viewed from the upper front left side, where an auxiliary cover 60 is detached from a main cover 58.

FIG. 5 is a perspective view of a cover body 70 of the auxiliary cover 60 according to the first embodiment as viewed from the lower rear left side.

FIG. 6 is an exploded perspective view of the auxiliary cover 60 according to the first embodiment as viewed from the upper rear left side.

FIG. 7 is a longitudinal cross-sectional view of a locking member 76 of the auxiliary cover 60 according to the first embodiment.

FIG. 8 is a perspective view of the auxiliary cover 60 according to the first embodiment as viewed from the lower rear right side, where the distance between a first contact member 80

and a second contact member 82 is reduced.

FIG. 9 is a perspective view of the auxiliary cover 60 according to the first embodiment as viewed from the lower rear right side, where the distance between the first contact member 80 and the second contact member 82 is increased.

FIG. 10 is a right side view of the front portion of the power tool 2 according to the first embodiment.

FIG. 11 is a perspective view of a power tool 102 according to a second embodiment as viewed from the upper front right side.

FIG. 12 is a perspective view of a cover unit 104 according to the second embodiment as viewed from the upper rear left side.

FIG. 13 is a perspective view of the cover unit 104 according to the second embodiment as viewed from the upper rear left side, where an auxiliary cover 106 is detached from a main cover 58.

FIG. 14 is a perspective view of a cover body 108 of the auxiliary cover 106 according to the second embodiment as viewed from the lower rear left side.

FIG. 15 is a perspective view of the auxiliary cover 106 according to the second embodiment as viewed from the lower rear right side.

FIG. 16 is a perspective view of a ruler unit 136 according to the second embodiment.

FIG. 17 is another perspective view of the ruler unit 136 according to the second embodiment.

FIG. 18 is a perspective view of a movable plate 140 of the ruler unit 136 according to the second embodiment.

FIG. 19 is a longitudinal cross-sectional view of the power tool 102 according to the second embodiment, illustrating how a chamfer amount C is measured by the ruler unit 136 with the distance between a first contact member 80 and a second contact member 82 reduced.

FIG. 20 is a longitudinal cross-sectional view of the power tool 102 according to the second embodiment, illustrating how the chamfer amount C is measured by the ruler unit 136 with the distance between the first contact member 80 and the second contact member 82 increased.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved power tools, cover units, and auxiliary covers as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A power tool disclosed herein may comprise a motor; a power transmission mechanism coupled to the motor; a housing that houses the motor and the power transmission mechanism; a holding part coupled to the power transmission mechanism; a tip tool held by the holding part and rotatable about a rotation axis; and a cover unit. The cover unit may comprise: a main cover attached to the housing and covering at least a part of the tip tool; and an auxiliary cover detachably attached to the main cover. The auxiliary cover may comprise: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

A cover unit for a power tool disclosed herein may comprise: a main cover; and an auxiliary cover detachably attached to the main cover. The auxiliary cover may comprise: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

An auxiliary cover of a cover unit for a power tool disclosed herein may comprise: a cover body; a first contact member supported by the cover body and including a first flat contact surface; and a second contact member supported by the cover body and including a second flat contact surface inclined relative to the first flat contact surface. A distance between the first contact member and the second contact member may be adjustable.

The configurations above enable changing the positional relationship between the first flat contact surface and the second flat contact surface without requiring component replacement.

In one or more embodiments, the auxiliary cover may further comprise a locking member configured to lock the auxiliary cover in a state of being attached to the main cover.

The configuration above prevents an unintentional removal of the auxiliary cover from the main cover.

In one or more embodiments, the auxiliary cover may further comprise: a metallic engagement member configured to engage the main cover; and a rubber sealing member disposed between the engagement member and the cover body.

The configuration above prevents dust generated by machining with the tip tool from leaking out through a gap between the engagement member and the cover body.

In one or more embodiments, the auxiliary cover may further comprise a metallic sliding plate movably supported by the cover body. The first contact member may be fixed to the cover body. The second contact member may be fixed to the sliding plate.

The configuration above enables adjustment of the distance between the first contact member and the second contact member with a simple arrangement.

In one or more embodiments, the auxiliary cover may further comprise a fastener member configured to fix the sliding plate to the cover body.

In the configuration above, loosening the fastener member allows the sliding plate to become movable relative to the cover body, and tightening the fastener member allows the sliding plate to be fixed in position relative to the cover body.

In one or more embodiments, the cover body may further comprise: a side wall disposed radially outward of the tip tool as viewed from the rotation axis; and a reinforcement portion disposed radially outward of the side wall as viewed from the rotation axis and disposed to face the sliding plate.

The configuration above prevents the sliding plate from being significantly bent even when the power tool falls and the sliding plate hits the floor.

In one or more embodiments, the first contact member may be configured to be detachably attached to the cover body.

The configuration above enables an easy replacement of the first contact member with a new first contact member when the first contact member is worn out as a result of repeated contact with workpieces.

In one or more embodiments, the second contact member may be configured to be detachably attached to the sliding plate.

The configuration above enables an easy replacement of the second contact member with a new second contact member when the second contact member is worn out as a result of repeated contact with workpieces.

In one or more embodiments, the first contact member and the second contact member may be identical to each other.

The configuration above allows for a reduction in kinds of components used for the auxiliary cover.

In one or more embodiments, the power tool may further comprise a grip configured to be gripped by a user. As viewed from the rotation axis, the first contact member may be disposed on an opposite side to the grip and the second contact member may be disposed on a same side as the grip. The first contact member may be immovable relative to the cover body. The second contact member may be movable relative to the cover body.

According to the configuration above, the first contact member located farther away from the user is immovable relative to the cover body when the distance between the first contact member and the second contact member is increased, thereby preventing the auxiliary cover from moving away from the user or being deformed.

In one or more embodiments, the second contact member may be movable in a first direction relative to the cover body. The rotation axis may extend in a second direction perpendicular to the first direction.

The configuration above facilitates machining a corner of a workpiece by contacting the first flat contact surface and the second flat contact surface with a first surface and a second surface forming the corner of the workpiece, respectively.

In one or more embodiments, the tip tool may be a wheel-shaped grinding tool.

The configuration above facilitates chamfering corners of workpieces.

In one or more embodiments, the main cover may comprise a dust collection nozzle.

The configuration above allows dust generated by machining with the tip tool to be collected through the nozzle.

In one or more embodiments, the auxiliary cover may further comprise a rubber holding member configured to engage the main cover.

The configuration above more efficiently prevents dust generated by machining with the tip tool from leaking out through a gap between the auxiliary cover and the main cover.

In one or more embodiments, the auxiliary cover may further comprise a ruler unit configured to measure a chamfer amount produced by chamfering performed while the first flat contact surface and the second flat contact surface are in contact with a workpiece.

The configuration above allows for an accurate measurement of chamfer amount in chamfering.

In one or more embodiments, the ruler unit may comprise: a first member comprising a first contact portion configured to contact the first flat contact surface and a second contact portion configured to contact the second flat contact surface; and a second member including a reference surface configured to contact the tip tool, wherein the second member is configured to hold the first member movably in a direction along the rotation axis.

The configuration above allows for an accurate measurement of a chamfer amount in chamfering with a simple arrangement.

In one or more embodiments, one of the first member and the second member may comprise a plurality of recesses arranged in the direction along the rotation axis. Another of the first member and the second member may comprise a protrusion configured to engage one of the plurality of recesses.

The configuration above improves the user’s tactile feel when the user moves the first member relative to the second member.

In one or more embodiments, the ruler unit may be configured to be detachably attached to the cover body.

The configuration above prevents the ruler unit from being misplaced or lost when the ruler unit is not in use.

### First Embodiment

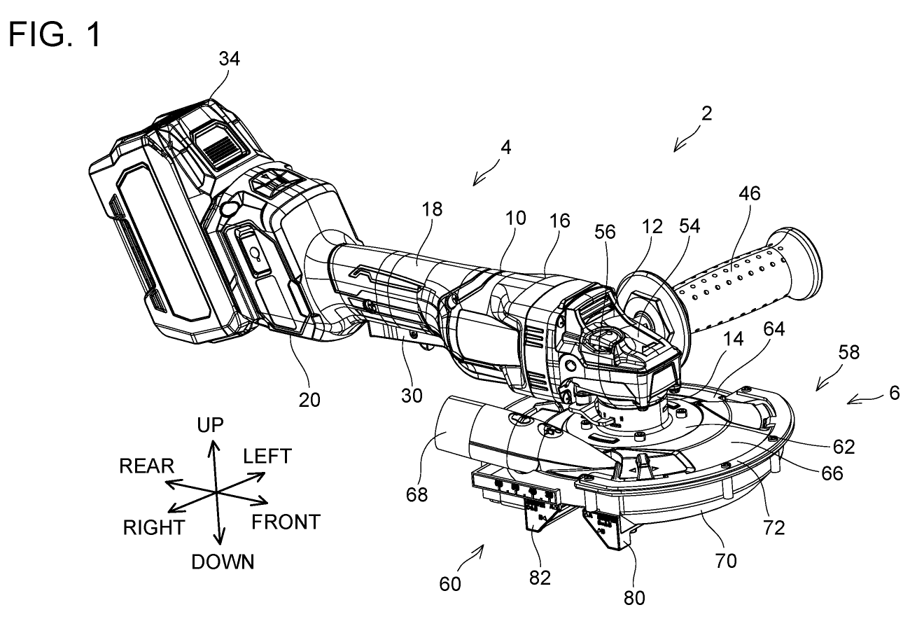

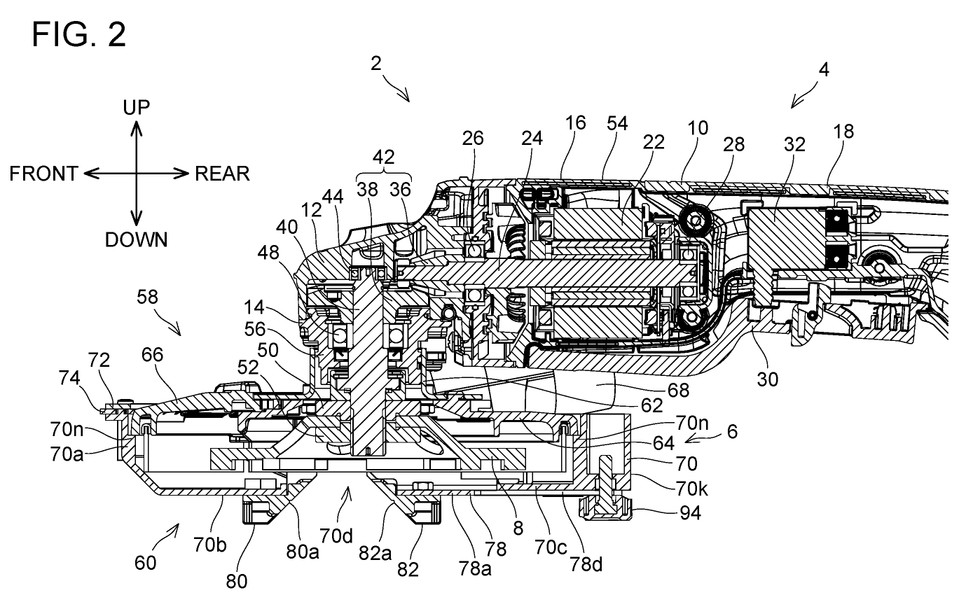

As illustrated in FIG. 1, a power tool 2 according to the present embodiment comprises a grinder 4 and a cover unit 6. The cover unit 6 is attached to the grinder 4 for use. The grinder 4 can grind workpieces such as concrete, blocks, bricks, or stones by rotation of a diamond cup 8 (see FIG. 2), which is a wheel-shaped grinding tool. Hereinafter, the longitudinal direction of the grinder 4 is termed a front-rear direction, the direction of rotation axis of the diamond cup 8 is termed an up-down direction, and a direction perpendicular to both the front-rear direction and the up-down direction is termed a right-left direction.

The grinder 4 comprises a body housing 10, a gear housing 12, and a bearing box 14. The body housing 10 comprises a motor housing portion 16, a grip 18 located rearward of the motor housing portion 16, and a battery pack attachment portion 20 located rearward of the grip 18.

As illustrated in FIG. 2, a motor 22 is housed in the motor housing portion 16 of the body housing 10. The motor 22 includes a drive shaft 24 extending in the front-rear direction. The drive shaft 24 is rotatably supported by the body housing 10 via bearings 26, 28. The grip 18 is shaped so that a user can grip the grip 18 with one hand. A trigger lever 30 is located below the grip 18. The trigger lever 30 is configured to be operated with finger(s) of the user while the user is gripping the grip 18. A trigger switch 32 is housed within the grip 18. The trigger switch 32 detects the operation on the trigger lever 30. As illustrated in FIG. 1, the battery pack attachment portion 20 is configured to allow a battery pack 34 comprising secondary battery cells such as lithium-ion battery cells (not illustrated) to be detachably attached thereto. A control circuit board (not illustrated) is housed within the battery pack attachment portion 20. The control circuit board supplies power from the battery pack 34 to the motor 22 when the trigger switch 32 is operated, and stops the power supply from the battery pack 34 to the motor 22 when the operation on the trigger switch 32 is released. The motor 22 rotates the drive shaft 24 (see FIG. 2) using the power supplied from the battery pack 34.

As illustrated in FIG. 2, the gear housing 12 is attached to a front portion of the motor housing portion 16 of the body housing 10. A first bevel gear 36 and a second bevel gear 38 arranged to mesh with each other are housed within the gear housing 12. The first bevel gear 36 is fixed to a front end portion of the drive shaft 24. The second bevel gear 38 is fixed to an upper end portion of a spindle 40 extending in the up-down direction. Hereinafter, the first bevel gear 36 and the second bevel gear 38 may be simply referred to bevel gears 42. The bevel gears 42 form a speed reduction mechanism that reduces the rotation of the motor 22 and transmits it to the spindle 40. In other words, the bevel gears 42 form a power transmission mechanism. The gear housing 12 holds the upper end portion of the spindle 40 via a bearing 44. As illustrated in FIG. 1, an auxiliary handle 46 is detachably attached to a side surface of the gear housing 12. To use the power tool 2, the user can grip the grip 18 of the body housing 10 with one hand and grip the auxiliary handle 46 with the other hand.

As illustrated in FIG. 2, the bearing box 14 is attached to a lower portion of the gear housing 12. The bearing box 14 holds the spindle 40 via a bearing 48. The spindle 40 is rotatable relative to the bearing box 14 about its rotation axis extending in the up-down direction. The diamond cup 8 is attachable to a lower end portion of the spindle 40 via an inner flange 50 and an outer flange 52. The inner flange 50 is fitted to the spindle 40. The diamond cup 8 is attached to the spindle 40 from below the inner flange 50 and fitted to the inner flange 50. The outer flange 52 is screwed into the spindle 40 from the lower end of the spindle 40. The diamond cup 8 is held between the inner flange 50 and the outer flange 52. Rotation of the drive shaft 24 of the motor 22 causes the diamond cup 8 as well as the spindle 40 to rotate about the rotation axis, thereby grinding a workpiece by the grinder 4. The spindle 40 can be regarded as a holding part configured to hold the diamond cup 8 which is a tip tool. Hereinafter, the body housing 10, the gear housing 12, and the bearing box 14 may be collectively termed a housing 54.

The cover unit 6 is attached to a cover attachment portion 56 of the bearing box 14.

The cover unit 6 is shaped such that it covers the periphery of the diamond cup 8 when attached to the grinder 4. The cover unit 6 prevents dust from scattering to the surroundings when the diamond cup 8 grinds a workpiece and is used to collect the dust by a dust collector (not illustrated).

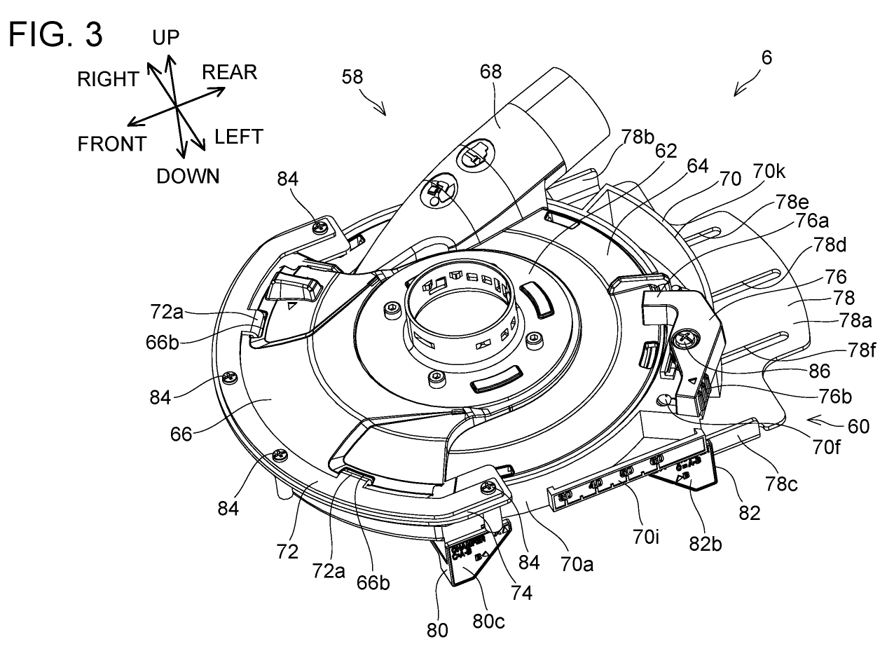

As illustrated in FIG. 3, the cover unit 6 comprises a main cover 58 and an auxiliary cover 60. The main cover 58 is detachably attached to the cover attachment portion 56 (see FIG. 2) of the grinder 4. The auxiliary cover 60 is detachably attached to the main cover 58. The user can use the power tool 2 with the auxiliary cover 60 detached from the main cover 58, and can also use the power tool 2 with the auxiliary cover 60 attached to the main cover 58.

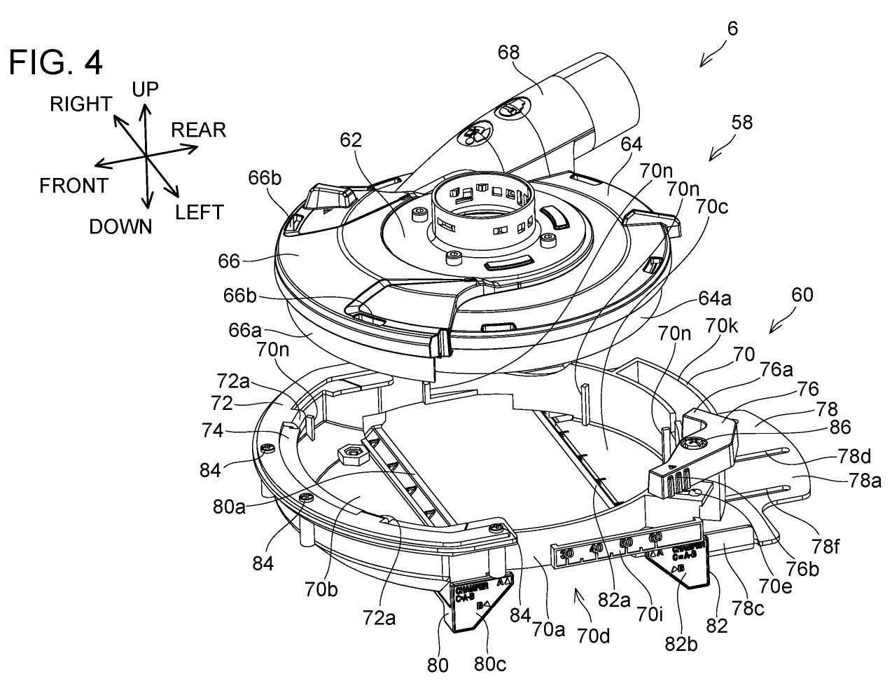

As illustrated in FIG. 4, the main cover 58 comprises a base 62, a fixed cover 64, a movable cover 66, and a nozzle 68. When the main cover 58 is attached to the grinder 4, the base 62 is rotatably supported by the cover attachment portion 56 of the grinder 4 about its rotation axis. The rotation axis of the base 62 is substantially coaxial with the rotational axis of spindle 40. The cover attachment portion 56 is configured to fix the base 62 at a desired rotation angle. The fixed cover 64 is fixed to the base 62. The movable cover 66 is rotatably supported by the base 62 about its rotation axis. When the main cover 58 is attached to the grinder 4, the rotation axis of the movable cover 66 is substantially coaxial with the rotation axis of the spindle 40. The fixed cover 64 is shaped to cover a part of the upper surface of the diamond cup 8, and the movable cover 66 is shaped to cover the rest of the upper surface of the diamond cup 8. Brush bristles 64a and 66a are attached to the outer periphery of the fixed cover 64 and the outer periphery of the movable cover 66, respectively, and the brush bristles 64a and 66a cover the side surface of the diamond cup 8. When the main cover 58 illustrated in FIG. 4 is attached to the grinder 4, the upper surface and side surface of the diamond cup 8 are completely covered by the fixed cover 64 and the movable cover 66. When the movable cover 66 is rotated relative to the base 62, the upper surface and side surface of the diamond cup 8 are thereby partially exposed. The nozzle 68 is formed integrally with the fixed cover 64. The internal space of the nozzle 68 is in communication with the internal space of the fixed cover 64. The nozzle 68 is configured to allow a hose (not illustrated) extending from a dust collector (not illustrated) to be detachably attached thereto. Dust generated by the diamond cup 8 grinding a workpiece is collected into the dust collector from the main cover 58 of the cover unit 6 through the nozzle 68 and the hose.

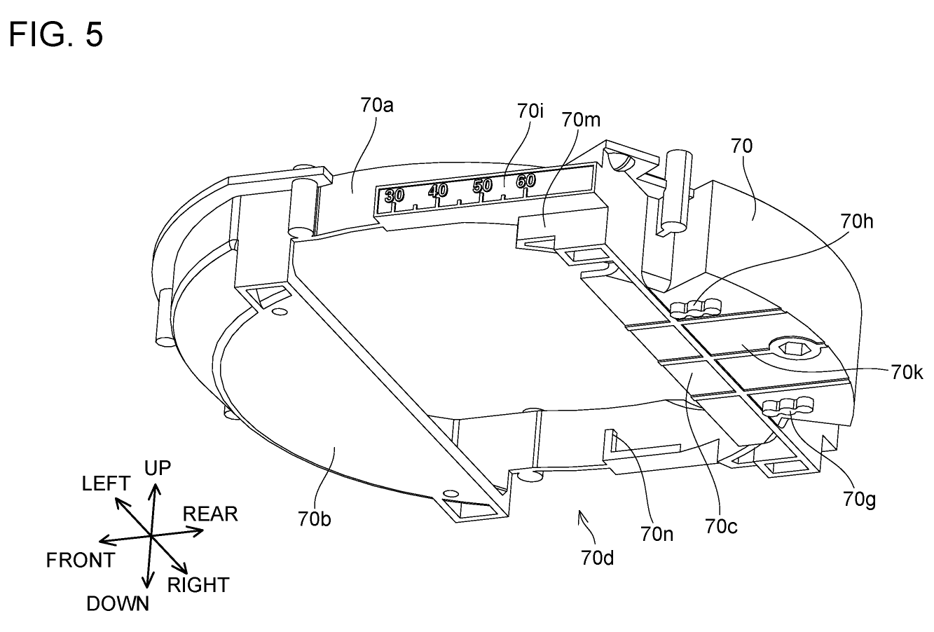

The auxiliary cover 60 comprises a plastic cover body 70, a metallic engagement member 72, a rubber sealing member 74, a plastic locking member 76, a metallic sliding plate 78, a plastic first contact member 80, and a plastic second contact member 82. As illustrated in FIG. 5, the cover body 70 comprises a side wall 70a that is located outward of the brush bristles 64a, 66a of the main cover 58 and entirely surrounds an upper portion of the side surface of the diamond cup 8, a lower front wall 70b covering a front portion of the lower surface of the diamond cup 8, and a lower rear wall 70c covering a rear portion of the lower surface of the diamond cup 8. The rear end of the lower front wall 70b extends linearly in the right-left direction between right and left portions of the side wall 70a. The front end of the lower rear wall 70c extends linearly in the right-left direction between the right and left portions of the side wall 70a. An opening 70d is defined between the lower front wall 70b and the lower rear wall 70c. As illustrated in FIG. 4, a plurality of support ribs 70n is located on the inner surface of the side wall 70a, and the support ribs 70n extend in the up-down direction and are arranged along a circumferential direction.

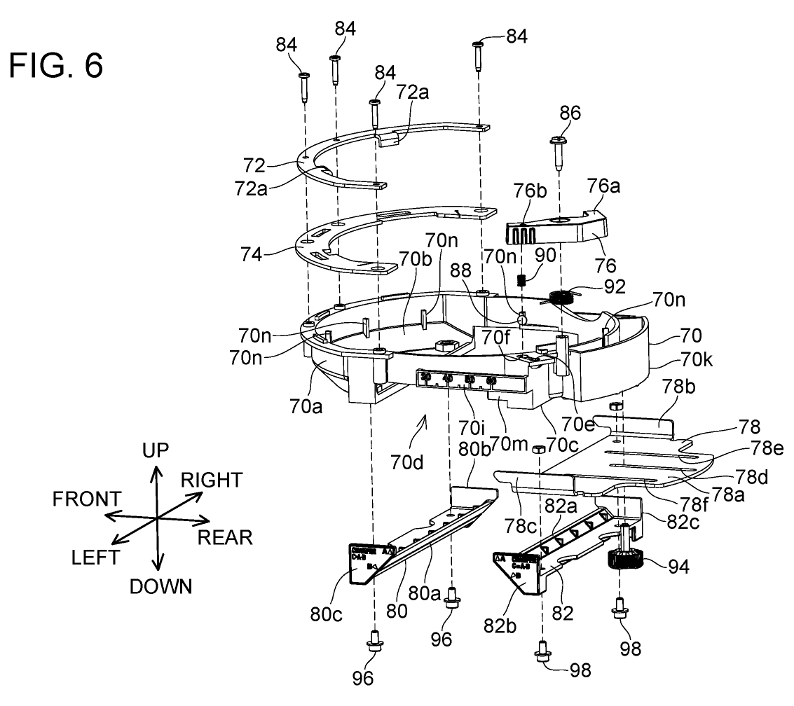

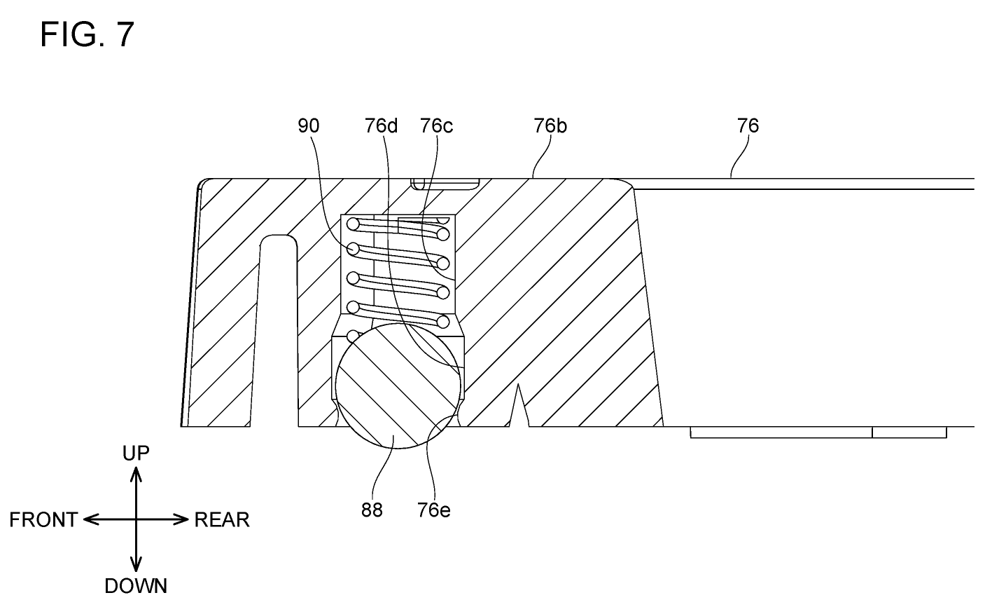

As illustrated in FIG. 6, the engagement member 72 is fixed, via the sealing member 74, to a front portion of the upper surface of the side wall 70a of the cover body 70 with fasteners 84. As illustrated in FIG. 3, the engagement member 72 includes an engagement claw 72a configured to engage an engagement groove 66b formed in the upper surface of the main cover 58 (e.g., the upper surface of the movable cover 66). The locking member 76 is fixed to a rear portion of the upper surface of the cover body 70 with a fastener 86. The locking member 76 is rotatably supported by the cover body 70 about its rotation axis extending in the up-down direction. The locking member 76 comprises an engagement portion 76a and an operation portion 76b. As illustrated in FIG. 7, a ball guide hole 76c is formed in the operation portion 76b. A ball 88 and a compression spring 90 are attached to the ball guide hole 76c. The ball guide hole 76c comprises a guide portion 76d having a slightly larger inner diameter than the outer diameter of the ball 88 and a stopper portion 76e having a slightly smaller inner diameter than the outer diameter of the ball 88. The ball 88 is housed in the guide portion 76d. The compression spring 90 biases the ball 88 downward relative to the locking member 76. When the ball 88 is in contact with the stopper portion 76e, a lower portion of the ball 88 projects downward from the locking member 76. The lower portion of the ball 88 enters a first recess 70e or a second recess 70f (illustrated in FIG. 6) formed in the upper surface of the side wall 70a of the cover body 70. When the locking member 76 is in a posture in which the engagement portion 76a is positioned forward as illustrated in FIG. 3 (this posture may be referred to as “lock posture” hereinafter), the ball 88 in the operation portion 76b is received in the first recess 70e. When the locking member 76 is in a posture in which the engagement portion 76a is positioned rearward as illustrated in FIG. 4 (this posture may be referred to as “unlock posture” hereinafter), the ball 88 in the operation portion 76b is received in the second recess 70f. As illustrated in FIG. 6, a torsion spring 92 is attached to the locking member 76. The torsion spring 92 biases the locking member 76 toward the lock posture. When the torsion spring 92 is applying a biasing force to the locking member 76 and the ball 88 in the operation portion 76b is received in the first recess 70e, the locking member 76 is maintained in the lock posture, and when the torsion spring 92 is applying a biasing force to the locking member 76 and the ball 88 in the operation portion 76b is received in the second recess 70f, the locking member 76 is maintained in the unlock posture.

To attach the auxiliary cover 60 illustrated in FIG. 4 to the main cover 58, first the engagement claw 72a of the auxiliary cover 60 is brought into engagement with the engagement groove 66b of the main cover 58 and the upper ends of the support ribs 70n on the side wall 70a of the auxiliary cover 60 are brought into contact with the lower surfaces of the fixed cover 64 and the movable cover 66 of the main cover 58. Then, the operation portion 76b of the locking member 76 is moved rearward to rotate the locking member 76 from the unlock posture to the lock posture as illustrated in FIG. 3, thereby causing the lower surface of the engagement portion 76a to contact the upper surface of the fixed cover 64. As a result, the engagement portion 76a engages the fixed cover 64, locking the auxiliary cover 60 in the state of being attached to the main cover 58.

To detach the auxiliary cover 60 illustrated in FIG. 3 from the main cover 58, first the operation portion 76b of the locking member 76 is moved forward to rotate the locking member 76 from the lock posture to the unlock posture so that the engagement portion 76a is disengaged from the fixed cover 64. Then, the side wall 70a of the auxiliary cover 60 is separated from the fixed cover 64 and the movable cover 66 of the main cover 58 and the engagement claw 72a of the auxiliary cover 60 is disengaged from the engagement groove 66b of the main cover 58, thereby detaching the auxiliary cover 60 from the main cover 58 as illustrated in FIG. 4.

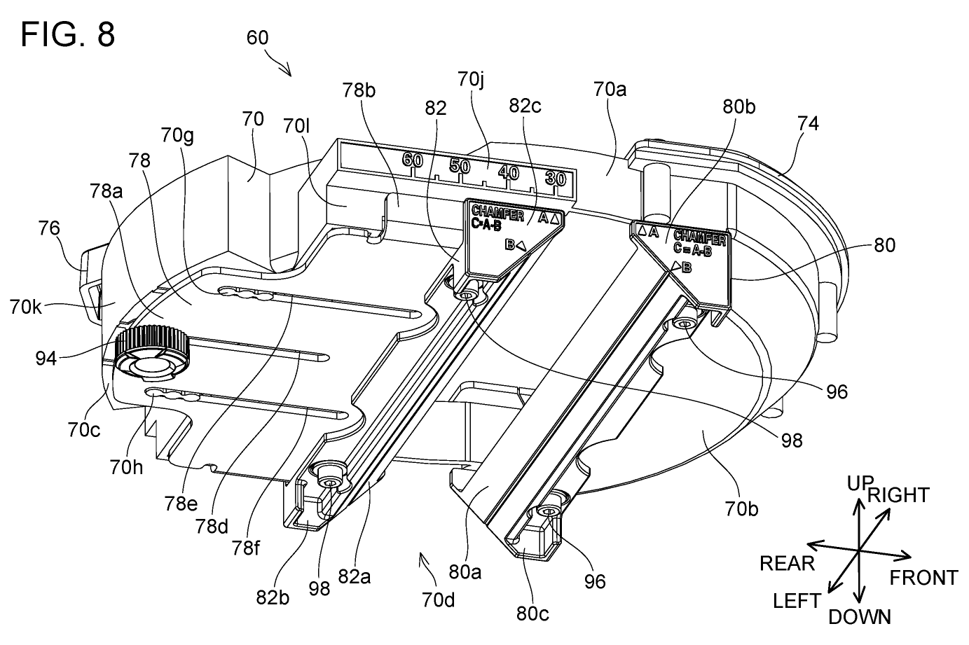

As illustrated in FIG. 6, the sliding plate 78 comprises a flat plate portion 78a, a right rail portion 78b bending upward from the right end of the plate portion 78a, and a left rail portion 78c bending upward from the left end of the plate portion 78a. A central elongated hole 78d, a right elongated hole 78e, and a left elongated hole 78f are formed in the plate portion 78a. The right elongated hole 78e is located rightward of the central elongated hole 78d and the left elongated hole 78f is located leftward of the central elongated hole 78d. The central elongated hole 78d, the right elongated hole 78e, and the left elongated hole 78f each have its longitudinal direction along the front-rear direction. As illustrated in FIG. 8, the sliding plate 78 is fixed to the lower surface of the lower rear wall 70c of the cover body 70 with a fastener member 94. The fastener member 94 extends through the central elongated hole 78d and is screwed into the lower rear wall 70c. When the fastener member 94 is loosened, the sliding plate 78 can move in the front-rear direction relative to the cover body 70. When the fastener member 94 is fastened after the sliding plate 78 has been moved to a desired position along the front-rear direction, the position of the sliding plate 78 is fixed relative to the cover body 70. As illustrated in FIG. 5, the lower rear wall 70c includes a right projection 70g and a left projection 70h. The right projection 70g and the left projection 70h project downward from the lower surface of the lower rear wall 70c. When the sliding plate 78 is attached to the cover body 70 as illustrated in FIG. 8, the right projection 70g is received in the right elongated hole 78e such that it is slidable therein in the front- rear direction and the left projection 70h is received in the left elongated hole 78f such that it is slidable therein in the front-rear direction. This guides the movement of the sliding plate 78 in the front-rear direction relative to the cover body 70. Further, the right rail portion 78b of the sliding plate 78 engages a right rail portion 70l formed on the right portion of the side wall 70a of the cover body 70 such that the right rail portion 78b is slidable in the front-rear direction. As illustrated in FIG. 6, the left rail portion 78c of the sliding plate 78 engages a left rail portion 70m formed on the left portion of the side wall 70a of the cover body 70 such that the left rail portion 78c is slidable in the front-rear direction. This also guides the movement of the sliding plate 78 in the front-rear direction relative to the cover body 70.

The first contact member 80 comprises a first flat contact surface 80a, a first marking surface 80b, and a second marking surface 80c. The first contact member 80 is fixed to the lower surface of the lower front wall 70b of the cover body 70 with fasteners 96. When the first contact member 80 is attached to the cover body 70, the first flat contact surface 80a is oriented rearward and downward and the rear end of the first flat contact surface 80a is located rearward of the rear end of the lower front wall 70b. In this state where the first contact member 80 is attached to the cover body 70, the first marking surface 80b is oriented rightward and is located rightward of the right portion of the side wall 70a. Further in this state where the first contact member 80 is attached to the cover body 70, the second marking surface 80c is oriented leftward and is located leftward of the left portion of the side wall 70a.

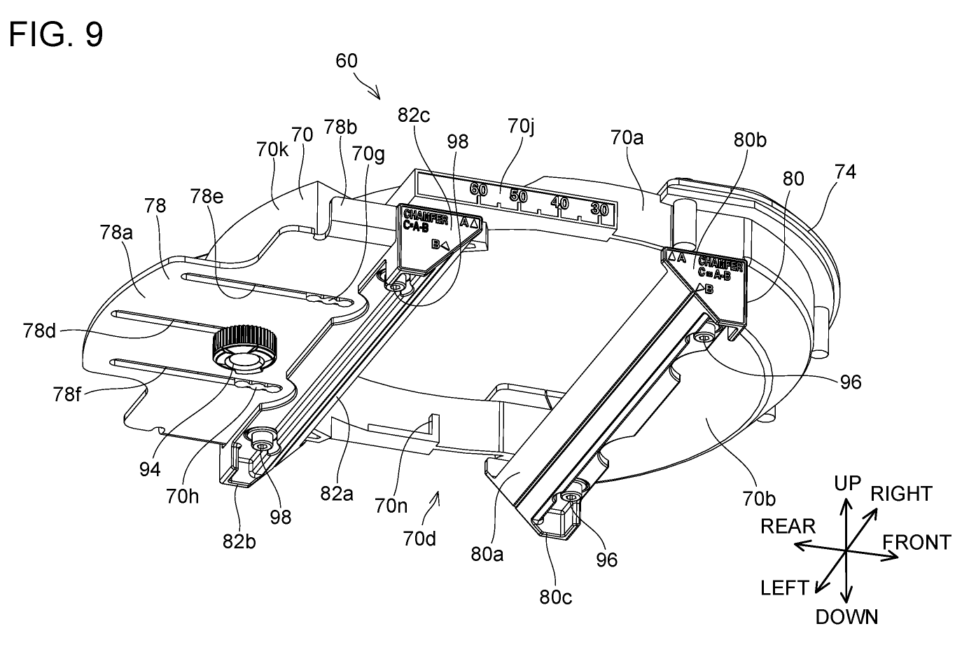

The second contact member 82 is identical to the first contact member 80. That is, the second contact member 82 is constituted of the same material as that of the first contact member 80 and has the same shape as that of the first contact member. The second contact member 82 comprises a second flat contact surface 82a, a first marking surface 82b, and a second marking surface 82c. The second contact member 82 is fixed to the lower surface of the plate portion 78a of the sliding plate 78 with fasteners 98. When the second contact member 82 is attached to the sliding plate 78, the second flat contact surface 82a is oriented forward and downward and the front end of the second flat contact surface 82a is located forward of the front end of the plate portion 78a. In this state where the second contact member 82 is attached to the sliding plate 78, the first marking surface 82b is oriented leftward and is located leftward of the left portion of the side wall 70a. Further in this state where the first contact member 80 is attached to the sliding plate 78, the second marking surface 82c is oriented rightward and is located rightward of the right portion of the side wall 70a. As illustrated in FIGS. 3 and 4, a left scale 70i corresponding to the first marking surface 82b of the second contact member 82 is formed on the left surface of the left portion of the side wall 70a of the cover body 70. As illustrated in FIGS. 8 and 9, a right scale 70j corresponding to the second marking surface 82c of the second contact member 82 is formed on the right surface of the right portion of the side wall 70a of the cover body 70.

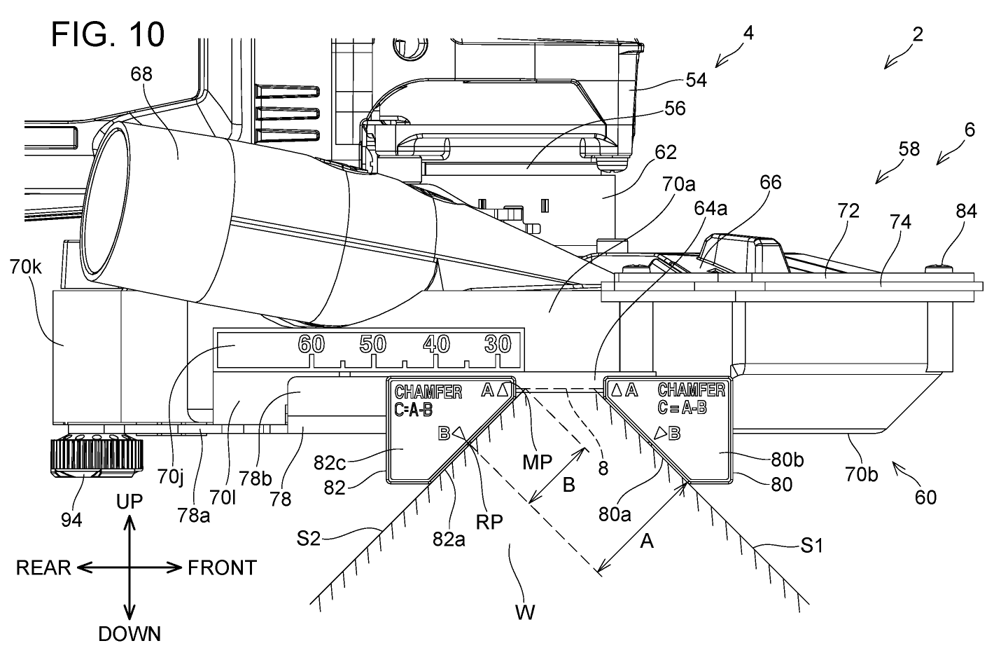

As illustrated in FIG. 10, a corner between a first surface S1 and a second surface S2 of a workpiece W may be chamfered by the diamond cup 8 with the first flat contact surface 80a of the auxiliary cover 60 in contact with the first surface S1 of the workpiece W and the second flat contact surface 82a of the auxiliary cover 60 in contact with the second surface S2 of the workpiece W. For this machining, a chamfer amount C is calculated by subtracting a distance B from a distance A, where the distance A is a distance along the second surface S2 from a reference point RP on the second contact member 82 to the first surface S1, and the distance B is a distance along the second surface S2 from the reference point RP on the second contact member 82 to the lower surface of the diamond cup 8. The distance A varies depending on the position of the second contact member 82 in the front-rear direction. The distance B remains constant regardless of the position of the second contact member 82 in the front-rear direction.

The second marking surface 82c indicates the position of a measurement point MP (illustrated as a combination of the letter A and triangle) for measuring the distance A using the combination of the position of the reference point RP on the second contact member 82 (illustrated as a combination of the letter B and triangle) and right scale 70j. The user can measure the distance A using the right scale 70j on the cover body 70 and the measurement point MP on the second marking surface 82c and then calculate the chamfer amount C from the distance A and the distance B. As illustrated in FIGS. 3 and 4, the first marking surface 82b also indicates the position of a measurement point MP (illustrated as a combination of the letter A and triangle) for measuring the distance A using the combination of the position of the reference point RP on the second contact member 82 (illustrated as a combination of the letter B and triangle) and the left scale 70i. The first marking surface 80b of the first contact member 80 has the same markings as those in the first marking surface 82b of the second contact member 82, and the second marking surface 80c of the first contact member 80 has the same markings as those on the second marking surface 82c of the second contact member 82.

As illustrated in FIG. 5, the cover body 70 includes a reinforcement portion 70k in its rear portion. The reinforcement portion 70k projects rearward beyond a rear portion of the side wall 70a. As illustrated in FIGS. 8 and 9, the reinforcement portion 70k faces the upper surface of the sliding plate 78. This prevents a rear portion of the sliding plate 78 from being significantly bent upward even when the power tool 2 falls and the sliding plate 78 hits the floor.

### Second Embodiment

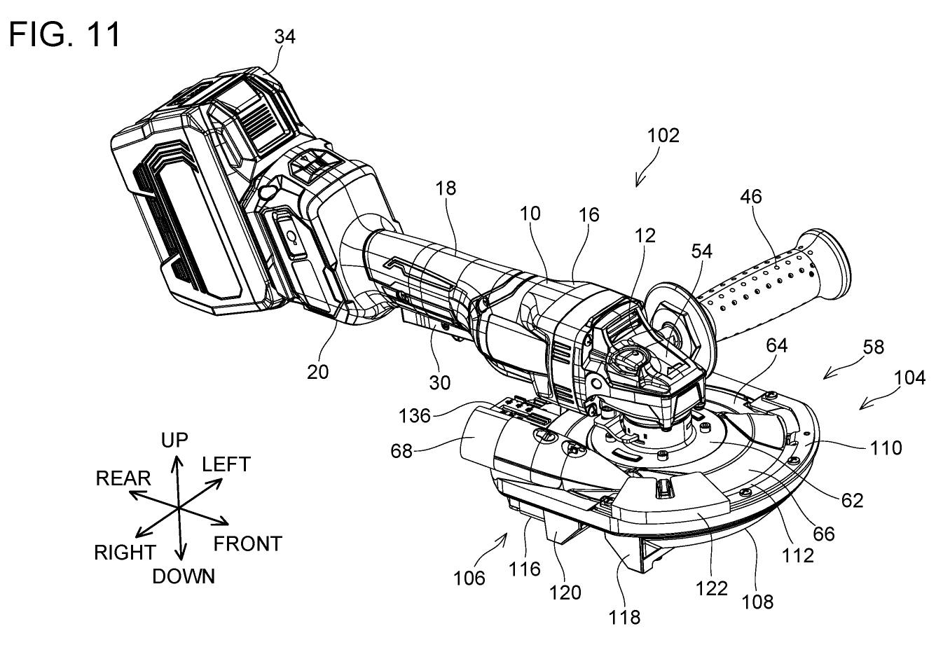

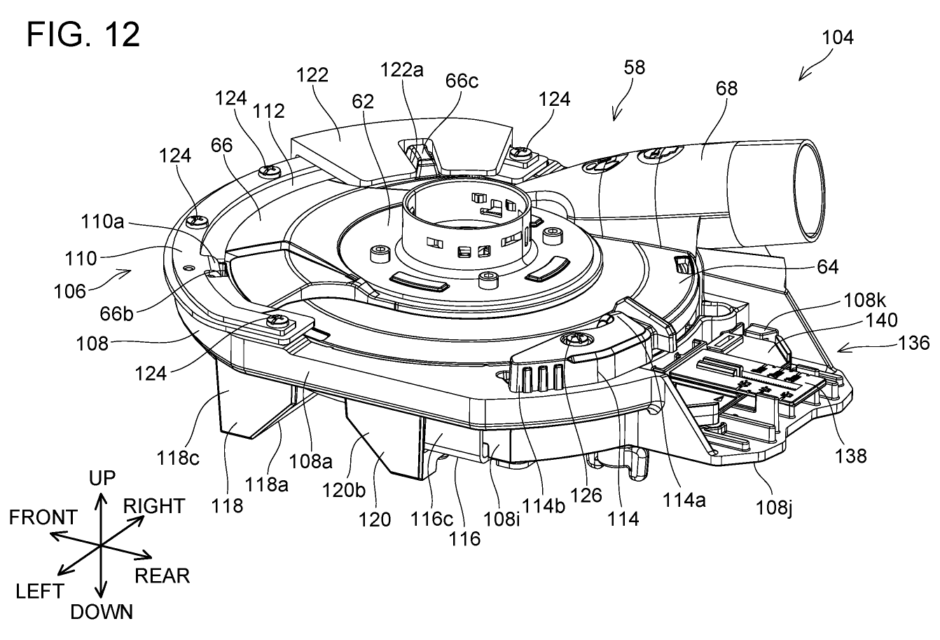

As illustrated in FIG. 11, a power tool 102 according to the present embodiment has substantially the same configuration as that of the power tool 2 according to the first embodiment. The power tool 102 comprises a cover unit 104 instead of the cover unit 6. As illustrated in FIG. 12, the cover unit 104 comprises an auxiliary cover 106 instead of the auxiliary cover 60.

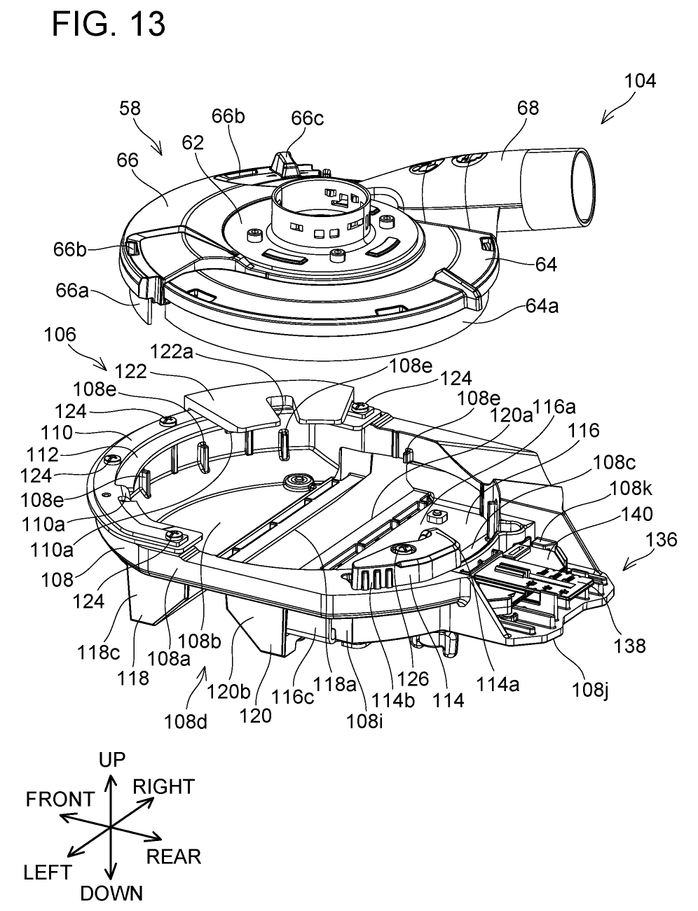

As illustrated in FIG. 13, the auxiliary cover 106 comprises a plastic cover body 108, a metallic engagement member 110, a rubber sealing member 112, a plastic locking member 114, a metallic sliding plate 116, a plastic first contact member 118, a plastic second contact member 120, and a rubber holding member 122.

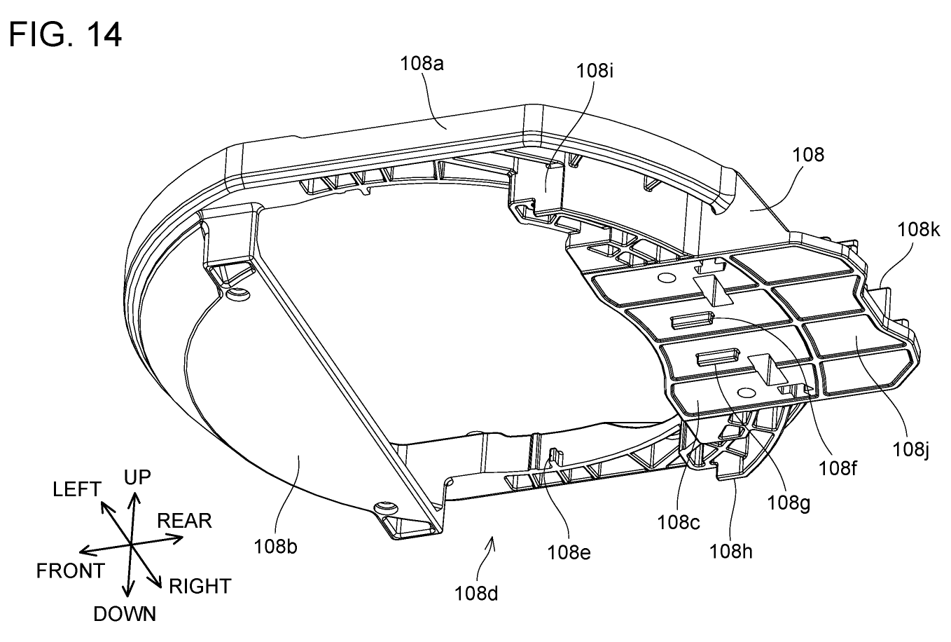

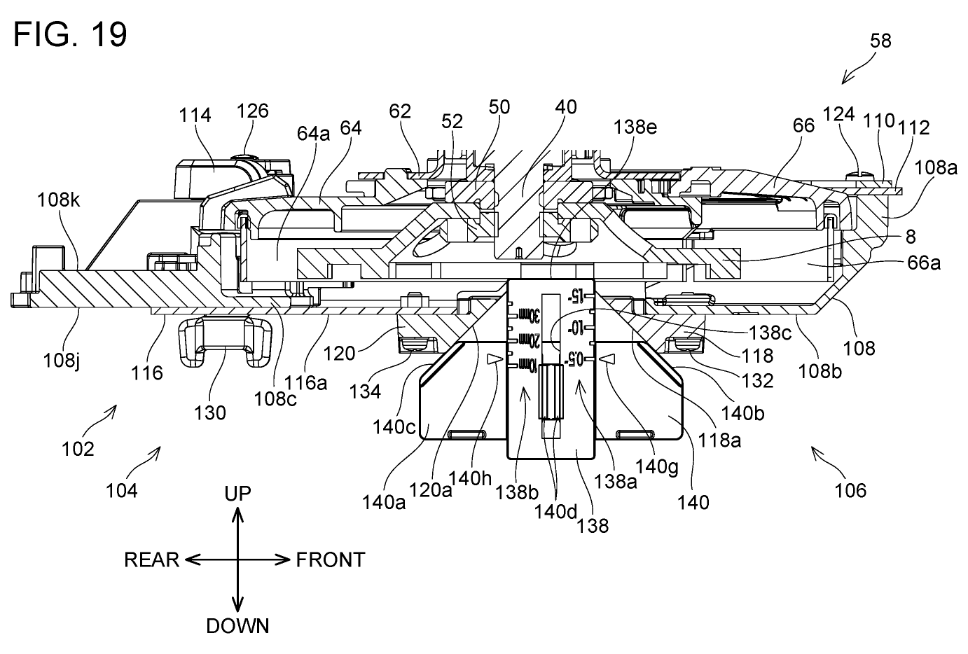

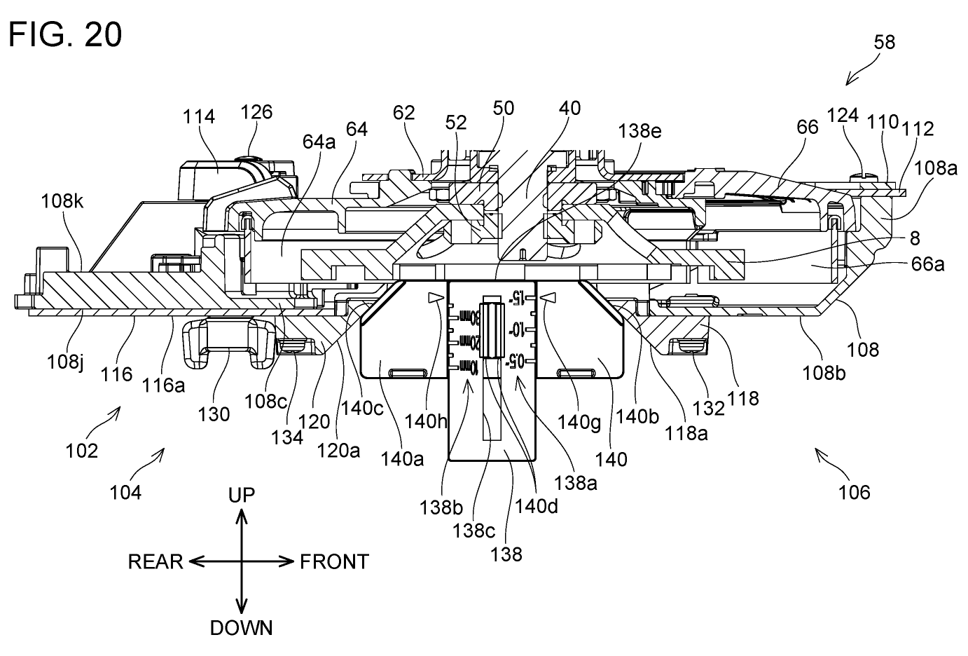

As illustrated in FIG. 14, the cover body 108 comprises a side wall 108a that is located outward of the brush bristles 64a, 66a (see FIG. 13) of the main cover 58 and entirely surrounds an upper portion of the side surface of the diamond cup 8 (see FIGS. 19 and 20), a lower front wall 108b covering a front portion of the lower surface of the diamond cup 8, and a lower rear wall 108c covering a space rearward of the diamond cup 8 from below. The rear end of the lower front wall 108b extends linearly in the right-left direction between right and left portions of the side wall 108a. The front end of the lower rear wall 108c is positioned slightly rearward of the rear end of the diamond cup 8 and extends in the right-left direction between the right and left portions of the side wall 108a. The configuration above facilitates attachment and detachment of the diamond cup 8 with the auxiliary cover 106 attached to the main cover 58. An opening 108d is defined between the lower front wall 108b and the lower rear wall 108c. A plurality of support ribs 108e is located on the inner surface of the side wall 108a. The support ribs 108e extend in the up-down direction and are arranged in a circumferential direction.

As illustrated in FIG. 13, the engagement member 110 is fixed, via the sealing member 112, to a front portion of the upper surface of the side wall 108a of the cover body 108 with fasteners 124. As illustrated in FIG. 12, the engagement member 110 includes an engagement claw 110a configured to engage the engagement groove 66b formed in the upper surface of the main cover 58 (e.g., the upper surface of the movable cover 66). The holding member 122 is integrally and seamlessly formed with the sealing member 112. That is, the holding member 122 and the sealing member 112 are formed integrally and constitute an integrated component. In a modification, the holding member 122 and the sealing member 112 may be separate components. The holding member 122 covers front and upper portions of the engagement member 110, and when the auxiliary cover 106 is attached to the main cover 58, the holding member 122 overlaps the upper surface of the main cover 58 (e.g., the upper surface of the movable cover 66). A slit 122a is formed in the holding member 122, and the slit 122a is configured to engage a projection 66c on the upper surface of the movable cover 66.

The locking member 114 is fixed to a rear portion of the upper surface of the cover body 108 with a fastener 126. The locking member 114 is rotatably supported by the cover body 108 about its rotation axis extending in the up-down direction. The locking member 114 comprises an engagement portion 114a and an operation portion 114b. The locking member 114 has substantially the same configuration as that of the locking member 76 according to the first embodiment and is switchable between a posture in which the engagement portion 114a is positioned forward (this posture may be referred to as “lock posture” hereinafter) and a posture in which the engagement portion 114a is positioned rearward (this posture may be referred to as “unlock posture” hereinafter).

To attach the auxiliary cover 106 illustrated in FIG. 13 to the main cover 58, first the engagement claw 110a of the auxiliary cover 106 is brought into engagement with the engagement groove 66b of the main cover 58 while the locking member 114 is in the unlock posture, the slit 122a of the auxiliary cover 106 is brought into engagement with the projection 66c of the main cover 58, and the upper ends of the support ribs 108e on the side wall 108a of the auxiliary cover 106 are brought into contact with the lower surfaces of the fixed cover 64 and the movable cover 66 of the main cover 58. Then, the locking member 114 is rotated from the unlock posture to the lock posture. As a result, the engagement portion 114a engages the fixed cover 64, thereby locking the auxiliary cover 106 in the state of being attached to the main cover 58.

To detach the auxiliary cover 106 illustrated in FIG. 12 from the main cover 58, first the locking member 114 is rotated from the lock posture to the unlock posture so that the engagement portion 114a is disengaged from the fixed cover 64. Then, the side wall 108a of the auxiliary cover 106 is separated from the fixed cover 64 and the movable cover 66 of the main cover 58, the slit 122a of the auxiliary cover 106 is disengaged from the projection 66c of the main cover 58, and an engagement claw 110a of the auxiliary cover 106 is disengaged from the engagement groove 66b of the main cover 58, thereby detaching the auxiliary cover 106 from the main cover 58.

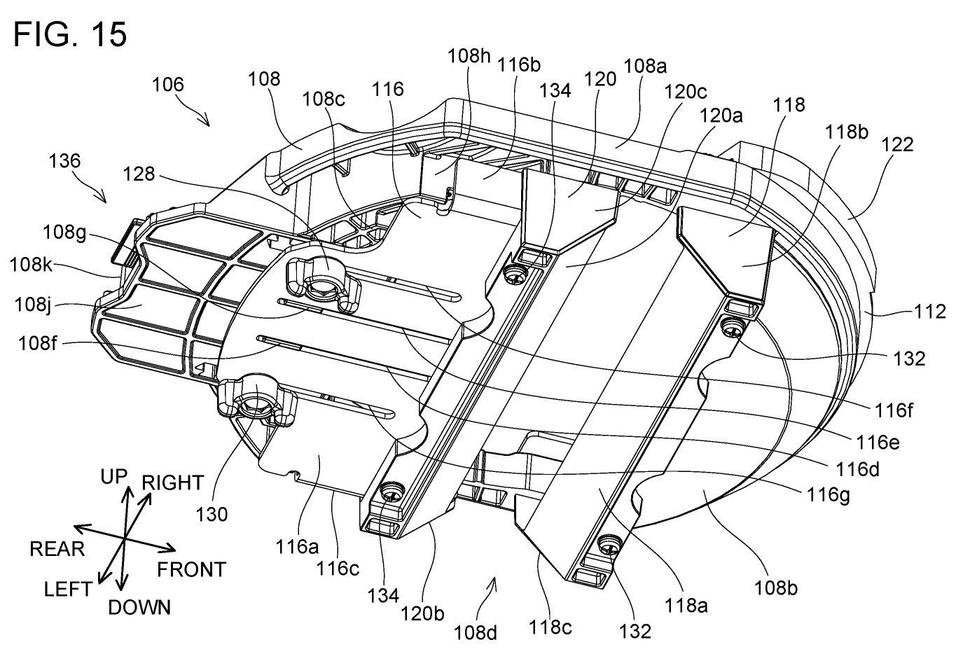

As illustrated in FIG. 15, the sliding plate 116 comprises a flat plate portion 116a, a right rail portion 116b bending upward from the right end of the plate portion 116a, and a left rail portion 116c bending upward from the left end of the plate portion 116a. A first central elongated hole 116d, a second central elongated hole 116e, a right elongated hole 116f, and a left elongated hole 116g are formed in the plate portion 116a. The first central elongated hole 116d and the second central elongated hole 116e are arranged side by side in the right-left direction. The right elongated hole 116f is located rightward of the second central elongated hole 116e and the left elongated hole 116g is located leftward of the first central elongated hole 116d. The first central elongated hole 116d, the second central elongated hole 116e, the right elongated hole 116f, and the left elongated hole 116g each have its longitudinal direction along the front-rear direction.

The sliding plate 116 is fixed to the lower surface of the lower rear wall 108c of the cover body 108 with a right fastener member 128 and a left fastener member 130. The right fastener member 128 extends through the right elongated hole 116f and is fastened to the lower rear wall 108c. The left fastener member 130 extends through the left elongated hole 116g and is fastened to the lower rear wall 108c. When the right fastener member 128 and the left fastener member 130 are loosened, the sliding plate 116 can move in the front-rear direction relative to the cover body 108. When the right fastener member 128 and the left fastener member 130 are fastened after the sliding plate 116 has been moved to a desired position along the front-rear direction, the position of the sliding plate 116 is fixed relative to the cover body 108.

As illustrated in FIG. 14, the lower rear wall 108c includes a first projection 108f and a second projection 108g arranged side by side in the right-left direction. The first projection 108f and the second projection 108g each project downward from the lower surface of the lower rear wall 108c and have its longitudinal direction along the front-rear direction. When the sliding plate 116 is attached to the cover body 108 as illustrated in FIG. 15, the first projection 108f is received in the first central elongated hole 116d such that it is slidable therein in the front-rear direction and the second projection 108g is received in the second central elongated hole 116e such that it is slidable therein in the front-rear direction. This guides the movement of the sliding plate 116 in the front-rear direction relative to the cover body 108. Further, the right rail portion 116b of the sliding plate 116 engages a right rail portion 108h formed on the right portion of the side wall 108a of the cover body 108 such that the right rail portion 116b is slidable in the front-rear direction. As illustrated in FIG. 12, the left rail portion 116c of the sliding plate 116 engages a left rail portion 108i formed on the left portion of the side wall 108a of the cover body 108 such that the left rail portion 116c is slidable in the front-rear direction. This also guides the movement of the sliding plate 116 in the front-rear direction relative to the cover body 108.

As illustrated in FIG. 15, the first contact member 118 comprises a first flat contact surface 118a, a first side surface 118b, and a second side surface 118c. The first contact member 118 is fixed to the lower surface of the lower front wall 108b of the cover body 108 with fasteners 132. When the first contact member 118 is attached to the cover body 108, the first flat contact surface 118a is oriented rearward and downward and the rear end of the first flat contact surface 118a is located rearward of the rear end of the lower front wall 108b. When the first contact member 118 is attached to the cover body 108, the first side surface 118b is oriented rightward and the second side surface 118c is oriented leftward. Unlike the first marking surface 80b and the second marking surface 80c of the first contact member 80 according to the first embodiment, the first side surface 118b and the second side surface 118c of the first contact member 118 according to the present embodiment do not have any markings thereon.

The second contact member 120 is identical to the first contact member 118. That is, the second contact member 120 is constituted of the same material as that of the first contact member 118 and has the same shape as that of the first contact member 118. The second contact member 120 comprises a second flat contact surface 120a, a first side surface 120b, and a second side surface 120c. The second contact member 120 is fixed to the lower surface of the plate portion 116a of the sliding plate 116 with fasteners 134. When the second contact member 120 is attached to the sliding plate 116, the second flat contact surface 120a is oriented forward and downward and the front end of the second flat contact surface 120a is located forward of the front end of the plate portion 116a. When the second contact member 120 is attached to the sliding plate 116, the first side surface 120b is oriented leftward and the second side surface 120c is oriented rightward. Unlike the first marking surface 82b and the second marking surface 82c of the second contact member 82 according to the first embodiment, the first side surface 120b and the second side surface 120c of the second contact member 120 according to the present embodiment do not have any markings thereon. Further, unlike the cover body 70 according to the first embodiment, the cover body 108 according to the present embodiment does not include the left scale 70i or the right scale 70j.

The cover body 108 includes a reinforcement portion 108j in its rear portion. The reinforcement portion 108j projects rearward beyond a rear portion of the side wall 108a. The reinforcement portion 108j faces the upper surface of the sliding plate 116. This prevents a rear portion of the sliding plate 116 from being significantly bent upward even when the power tool 102 falls and the sliding plate 116 hits the floor.

As illustrated in FIG. 12, the auxiliary cover 106 further comprises a ruler unit 136. The ruler unit 136 is detachably attached to a ruler unit holding portion 108k formed on the upper surface of the reinforcement portion 108j of the cover body 108.

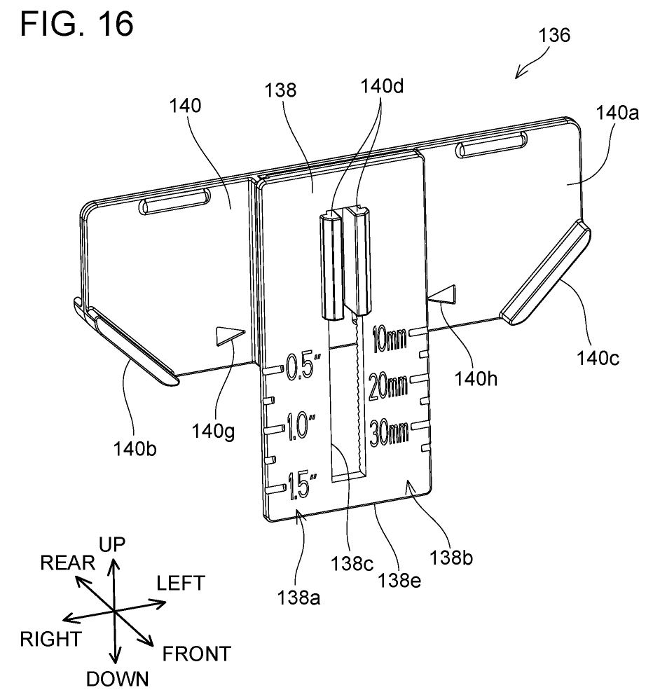

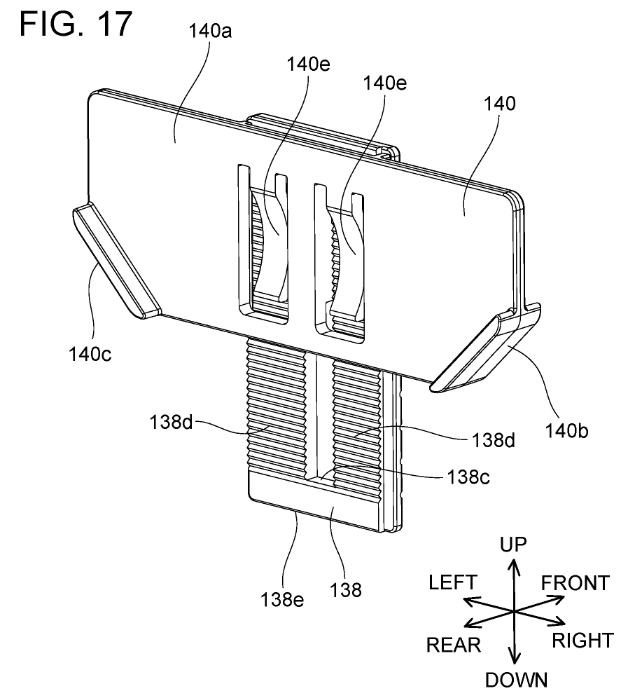

As illustrated in FIG. 16, the ruler unit 136 comprises a scale plate 138 and a movable plate 140. In the following description of the ruler unit 136, the longitudinal direction of the scale plate 138 is along the up-down direction and the longitudinal direction of the movable plate 140 is along the right-left direction. The scale plate 138 has a rectangular flat-plate shape having the longitudinal direction along the up-down direction and the transverse direction along the right-left direction. The scale plate 138 includes, on its surface, a first scale 138a for inch markings and a second scale 138b for millimeter markings. An elongated hole 138c is formed in a central portion of the scale plate 138. The elongated hole 138c penetrates the scale plate 138 from the front surface to the rear surface and extends in the longitudinal direction of the scale plate 138. As illustrated in FIG. 17, a plurality of recessed grooves 138d is formed in the rear surface of the scale plate 138, and the recessed grooves 138d are arranged in the longitudinal direction of the scale plate 138. Each of the recessed grooves 138d extends in the transverse direction of the scale plate 138. The scale plate 138 includes a reference surface 138e at its lower end.

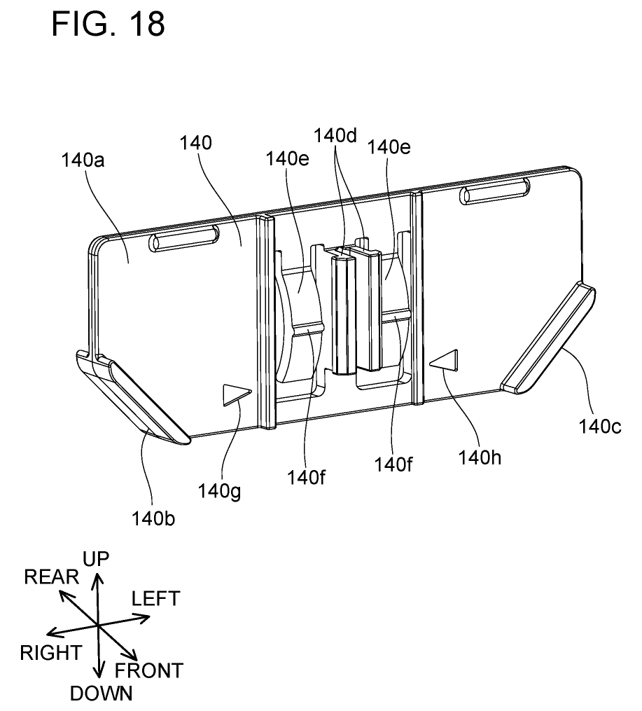

As illustrated in FIG. 18, the movable plate 140 comprises a base portion 140a having a trapezoidal flat-plate shape, a first contact plate 140b located on a lower-right inclined portion of the base portion 140a, a second contact plate 140c located on a lower-left inclined portion of the base portion 140a, engagement claws 140d projecting forward from the front surface of the base portion 140a, support portions 140e elastically deformable relative to the base portion 140a, and raised ridges 140f projecting forward from the front surfaces of the support portions 140e and extending in the longitudinal direction of the base portion 140a. As illustrated in FIG. 16, the movable plate 140 is attached to the scale plate 138 by inserting the engagement claws 140d into the elongated hole 138c of the scale plate 138 from the rear. The movable plate 140 is movable in the up-down direction relative to the scale plate 138. As illustrated in FIG. 17, when the movable plate 140 is attached to the scale plate 138, the raised ridges 140f (see FIG. 18) of the movable plate 140 each engage one of the recessed grooves 138d of the scale plate 138, thereby fixing the position of the movable plate 140 relative to the scale plate 138. When the user moves the movable plate 140 in the up-down direction relative to the scale plate 138, the raised ridges 140f of the movable plate 140 repeatedly come out from recessed grooves 138d of the scale plate 138 and enter other recessed grooves 138d, which provides a tactile clicking sensation to the user. As illustrated in FIG. 16, the movable plate 140 includes, on its front surface, a first reference marking 140g corresponding to the first scale 138a of the scale plate 138 and a second reference marking 140h corresponding to the second scale 138b of the scale plate 138.

With the power tool 102 according to the present embodiment, a chamfer amount C in chamfering, which is performed with the first flat contact surface 118a and the second flat contact surface 120a of the auxiliary cover 106 being in contact with a workpiece W, can be measured using the ruler unit 136. For this measurement, first the reference surface 138e of the scale plate 138 of the ruler unit 136 is brought into contact with the lower surface of the diamond cup 8 from below, as illustrated in FIGS. 19 and 20. Then, the movable plate 140 is moved relative to the scale plate 138 until the first contact plate 140b contacts the first flat contact surface 118a of the auxiliary cover 106 and the second contact plate 140c contacts the second flat contact surface 120a of the auxiliary cover 106. By reading the position of the first reference marking 140g relative to the first scale 138a or the position of the second reference marking 140h relative to the second scale 138b after the movable plate 140 has been moved, the chamfer amount C can be measured. In the example illustrated in FIG. 19, the chamfer amount C in chamfering by the power tool 102 is 0.5 inches (12.7 mm). In the example illustrated in FIG. 20, the chamfer amount C in chamfering by the power tool 102 is 1.5 inches (38.1 mm).

With the ruler unit 136 according to the present embodiment, the chamfer amount C in chamfering is measured with the reference surface 138e being in contact with the lower surface of the diamond cup 8. This allows for accurate measurement of the chamfer amount C in chamfering even if wear of the diamond cup 8 alters the position of its lower surface relative to the cover unit 104.

### Modifications

The cover units 6, 104 may be used in other types of power tools such as circular saws. In this case, tip tools different from the diamond cup 8 may be used in the power tools.

The ruler unit 136 may comprise a single member. In this case, the single member may include multiple combinations of reference surfaces for contact with the diamond cup 8, first contact plates for contact with the first flat contact surface 118a, and second contact plates for contact with the second flat contact surface 120a to measure the chamfer amount C in chamfering. Alternatively, the ruler unit 136 may comprise multiple members configured to be used separately. In this case, each of the multiple members may include a combination of a reference surface for contact with the diamond cup 8, a first contact plate for contact with the first flat contact surface 118a, and a second contact plate for contact with the second flat contact surface 120a to measure the chamfer amount C in chamfering.

### Features of Embodiments

As described above, in one or more embodiments, the power tool 2, 102 comprises the motor 22; the bevel gear 42 (an example of power transmission mechanism) coupled to the motor 22; the housing 54 that houses the motor 22 and the bevel gear 42; the spindle 40 (an example of holding part) coupled to the bevel gear 42; the diamond cup 8 (an example of tip tool) held by the spindle 40 and rotatable about its rotation axis; and the cover unit 6, 104. The cover unit 6, 104 comprises the main cover 58 attached to the housing 54 and covering at least a part of the diamond cup 8; and the auxiliary cover 60, 106 detachably attached to the main cover 58. The auxiliary cover 60, 106 comprises the cover body 70, 108; the first contact member 80, 118 supported by the cover body 70, 108 and including the first flat contact surface 80a, 118a; and the second contact member 82, 120 supported by the cover body 70, 108 and including the second flat contact surface 82a, 120a inclined relative to the first flat contact surface 80a, 118a. The distance between the first contact member 80, 118 and the second contact member 82, 120 is adjustable.

The configuration above enables changing the positional relationship between the first flat contact surface 80a, 118a and the second flat contact surface 82a, 120a without requiring component replacement.

In one or more embodiments, the auxiliary cover 60, 106 further comprises the locking member 76, 114 configured to lock the auxiliary cover 60, 106 in the state of being attached to the main cover 58.

The configuration above prevents an unintentional removal of the auxiliary cover 60, 106 from the main cover 58.

In one or more embodiments, the auxiliary cover 60, 106 further comprises the metallic engagement member 72, 110 configured to engage the main cover 58; and the rubber sealing member 74, 112 disposed between the engagement member 72, 110 and the cover body 70, 108.

The configuration above prevents dust generated by machining with the diamond cup 8 from leaking out through a gap between the engagement member 72, 110 and the cover body 70, 108.

In one or more embodiments, the auxiliary cover 60, 106 further comprises the metallic sliding plate 78, 116 movably supported by the cover body 70, 108. The first contact member 80, 118 is fixed to the cover body 70, 108. The second contact member 82, 120 is fixed to the sliding plate 78, 116.

The configuration above enables adjustment of the distance between the first contact member 80, 118 and the second contact member 82, 120 with a simple arrangement.

In one or more embodiments, the auxiliary cover 60, 106 further comprises the fastener member 94, the right and left fastener members 128, 130 (examples of fastener member) configured to fix the sliding plate 78, 116 to the cover body 70, 108.

In the configuration above, loosening the fastener member 94, the right and left fastener members 128, 130 allows the sliding plate 78, 116 to become movable relative to the cover body 70, 108, and tightening the fastener member 94, the right and left fastener members 128, 130 allows the sliding plate 78, 116 to be fixed in position relative to the cover body 70, 108.

In one or more embodiments, the cover body 70, 108 further comprises the side wall 70a, 108a disposed radially outward of the diamond cup 8 as viewed from the rotation axis of the diamond cup 8; and the reinforcement portion 70k, 108j disposed radially outward of the side wall 70a, 108a as viewed from the rotation axis of the diamond cup 8 and disposed to face the sliding plate 78, 116.

The configuration above prevents the sliding plate 78, 116 from being significantly bent even when the power tool 2, 102 falls and the sliding plate 78, 116 hits the floor.

In one or more embodiments, the first contact member 80, 118 is configured to be detachably attached to the cover body 70, 108.

The configuration above enables an easy replacement of the first contact member 80, 118 with a new first contact member 80, 118 when the first contact member 80, 118 is worn out as a result of repeated contact with workpieces W.

In one or more embodiments, the second contact member 82, 120 is configured to be detachably attached to the sliding plate 78, 116.

The configuration above enables an easy replacement of the second contact member 82, 120 with a new second contact member 82, 120 when the second contact member 82, 120 is worn out as a result of repeated contact with workpieces W.

In one or more embodiments, the first contact member 80 and the second contact member 82 are identical to each other, and the first contact member 118 and the second contact member 120 are identical to each other.

The configuration above allows for a reduction in kinds of components used for the auxiliary cover 60, 106.

In one or more embodiments, the power tool 2, 102 further comprises the grip 18 configured to be gripped by a user. As viewed from the rotation axis of the diamond cup 8, the first contact member 80, 118 is disposed on the opposite side to the grip 18 and the second contact member 82, 120 is disposed on the same side as the grip 18. The first contact member 80, 118 is immovable relative to the cover body 70, 108. The second contact member 82, 120 is movable relative to the cover body 70, 108.

According to the configuration above, the first contact member 80, 118 located farther away from the user is immovable relative to the cover body 70, 108 when the distance between the first contact member 80, 118 and the second contact member 82, 120 is increased, thereby preventing the auxiliary cover 60, 106 from moving away from the user or being deformed.

In one or more embodiments, the second contact member 82, 120 is movable in the front-rear direction (an example of first direction) relative to the cover body 70, 108. The rotation axis of the diamond cup 8 extends in the up-down direction (an example of second direction) perpendicular to the front-rear direction.

The configuration above facilitates machining a corner of a workpiece W by contacting the first flat contact surface 80a118a and the second flat contact surface 82a, 120a with the first surface S1 and the second surface S2 forming the corner of the workpiece W, respectively.

In one or more embodiments, the diamond cup 8 is a wheel-shaped grinding tool.

The configuration above facilitates chamfering corners of workpieces W.

In one or more embodiments, the main cover 58 comprises the dust collection nozzle 68.

The configuration above allows dust generated by machining with the diamond cup 8 to be collected via the nozzle 68.

In one or more embodiments, the auxiliary cover 106 further comprises the rubber holding member 122 configured to engage the main cover 58.

The configuration above more efficiently prevents dust generated by machining with the diamond cup 8 from leaking out through a gap between the auxiliary cover 106 and the main cover 58.

In one or more embodiments, the auxiliary cover 106 further comprises the ruler unit 136 configured to measure the chamfer amount C produced by chamfering performed while the first flat contact surface 118a and the second flat contact surface 120a are in contact with a workpiece W.

The configuration above allows for an accurate measurement of the chamfer amount C in chamfering.

In one or more embodiments, the ruler unit 136 comprises the movable plate 140 (an example of first member) comprising the first contact plate 140b (an example of first contact portion) configured to contact the first flat contact surface 118a and the second contact plate 140c (an example of second contact portion) configured to contact the second flat contact surface 120a; and the scale plate 138 (an example of second member) including the reference surface 138e configured to contact the diamond cup 8, wherein the scale plate 138 is configured to hold the movable plate 140 movably in the up-down direction (an example of direction along the rotation axis).

The configuration above allows for an accurate measurement of chamfer amount C in chamfering with a simple arrangement.

In one or more embodiments, the scale plate 138 comprises the plurality of recessed grooves 138d (an example of recesses) arranged in the up-down direction. The movable plate 140 comprises the raised ridges 140f (example of protrusion) each configured to engage one of the plurality of recessed grooves 138d.

The configuration above improves the user’s tactile feel when the user moves the movable plate 140 relative to the scale plate 138.

In one or more embodiments, the ruler unit 136 is configured to be detachably attached to the cover body 108.

The configuration above prevents loss of the ruler unit 136 when the ruler unit 136 is not in use.

What is claimed is:

1. A power tool comprising:
a motor;
a power transmission mechanism coupled to the motor;
a housing that houses the motor and the power transmission mechanism;
a holding part coupled to the power transmission mechanism;
a tip tool held by the holding part and rotatable about a rotation axis; and
a cover unit,
wherein the cover unit comprises:
a main cover attached to the housing and covering at least a part of the tip tool; and
an auxiliary cover detachably attached to the main cover,
the auxiliary cover comprises:
a cover body;
a first contact member supported by the cover body and including a first flat contact surface; and
a second contact member supported by the cover body and including a second flat contact surface inclined relative to the first flat contact surface, and
a distance between the first contact member and the second contact member is adjustable.

2. The power tool according to claim 1, wherein the auxiliary cover further comprises a locking member configured to lock the auxiliary cover in a state of being attached to the main cover.

3. The power tool according to claim 1, wherein the auxiliary cover further comprises:
a metallic engagement member configured to engage the main cover; and
a rubber sealing member disposed between the engagement member and the cover body.

4. The power tool according to claim 1, wherein the auxiliary cover further comprises a metallic sliding plate movably supported by the cover body,
the first contact member is fixed to the cover body, and
the second contact member is fixed to the sliding plate.

5. The power tool according to claim 4, wherein the auxiliary cover further comprises a fastener member configured to fix the sliding plate to the cover body.

6. The power tool according to claim 4, wherein the cover body further comprises:
a side wall disposed radially outward of the tip tool as viewed from the rotation axis; and
a reinforcement portion disposed radially outward of the side wall as viewed from the rotation axis and disposed to face the sliding plate.

7. The power tool according to claim 4, wherein the first contact member is configured to be detachably attached to the cover body.

8. The power tool according to claim 4, wherein the second contact member is configured to be detachably attached to the sliding plate.

9. The power tool according to claim 1, wherein the first contact member and the second contact member are identical to each other.

10. The power tool according to claim 1, further comprising a grip configured to be gripped by a user,
wherein as viewed from the rotation axis, the first contact member is disposed on an opposite side to the grip and the second contact member is disposed on a same side as the grip,
the first contact member is immovable relative to the cover body, and
the second contact member is movable relative to the cover body.

11. The power tool according to claim 10, wherein the second contact member is movable in a first direction relative to the cover body, and
the rotation axis extends in a second direction perpendicular to the first direction.

12. The power tool according to claim 11, wherein the tip tool is a wheel-shaped grinding tool.

13. The power tool according to claim 1, wherein the main cover comprises a dust collection nozzle.

14. The power tool according to claim 1, wherein the auxiliary cover further comprises a rubber holding member configured to engage the main cover.

15. The power tool according to claim 1, wherein the auxiliary cover further comprises a ruler unit configured to measure a chamfer amount produced by chamfering performed while the first flat contact surface and the second flat contact surface are in contact with a workpiece.

16. The power tool according to claim 15, wherein the ruler unit comprises:
a first member comprising a first contact portion configured to contact the first flat contact surface and a second contact portion configured to contact the second flat contact surface; and
a second member including a reference surface configured to contact the tip tool, wherein the second member is configured to hold the first member movably in a direction along the rotation axis.

17. The power tool according to claim 16, wherein one of the first member and the second member comprises a plurality of recesses arranged in the direction along the rotation axis, and
another of the first member and the second member comprises a protrusion configured to engage one of the plurality of recesses.

18. The power tool according to claim 15, wherein the ruler unit is configured to be detachably attached to the cover body.

19. The power tool according to claim 2, wherein the auxiliary cover further comprises:
a metallic engagement member configured to engage the main cover;
a rubber sealing member disposed between the engagement member and the cover body; and
a metallic sliding plate movably supported by the cover body,
the first contact member is fixed to the cover body,
the second contact member is fixed to the sliding plate,
the auxiliary cover further comprises a fastener member configured to fix the sliding plate to the cover body,
the cover body further comprises:
a side wall disposed radially outward of the tip tool as viewed from the rotation axis; and
a reinforcement portion disposed radially outward of the side wall as viewed from the rotation axis and disposed to face the sliding plate,
the first contact member is configured to be detachably attached to the cover body,
the second contact member is configured to be detachably attached to the sliding plate,
the first contact member and the second contact member are identical to each other,
the power tool further comprises a grip configured to be gripped by a user,
as viewed from the rotation axis, the first contact member is disposed on an opposite side to the grip and the second contact member is disposed on a same side as the grip,
the first contact member is immovable relative to the cover body,
the second contact member is movable relative to the cover body,
the second contact member is movable in a first direction relative to the cover body,
the rotation axis extends in a second direction perpendicular to the first direction,
the tip tool is a wheel-shaped grinding tool,
the main cover comprises a dust collection nozzle,
the auxiliary cover further comprises a rubber holding member configured to engage the main cover,
the auxiliary cover further comprises a ruler unit configured to measure a chamfer amount produced by chamfering performed while the first flat contact surface and the second flat contact surface are in contact with a workpiece,
the ruler unit comprises:
a first member comprising a first contact portion configured to contact the first flat contact surface and a second contact portion configured to contact the second flat contact surface; and
a second member including a reference surface configured to contact the tip tool, wherein the second member is configured to hold the first member movably in a direction along the rotation axis,
one of the first member and the second member comprises a plurality of recesses arranged in the direction along the rotation axis,
another of the first member and the second member comprises a protrusion configured to engage one of the plurality of recesses, and
the ruler unit is configured to be detachably attached to the cover body.

20. A cover unit for a power tool, comprising:
a main cover; and
an auxiliary cover detachably attached to the main cover,
wherein the auxiliary cover comprises:
a cover body;
a first contact member supported by the cover body and including a first flat contact surface; and
a second contact member supported by the cover body and including a second flat contact surface inclined relative to the first flat contact surface, and
a distance between the first contact member and the second contact member is adjustable.

21. An auxiliary cover of a cover unit for a power tool, comprising:
a cover body;
a first contact member supported by the cover body and including a first flat contact surface; and
a second contact member supported by the cover body and including a second flat contact surface inclined relative to the first flat contact surface, and
wherein a distance between the first contact member and the second contact member is adjustable.
